(19) United States
(12) Patent Application Publication
(10) Pub. No.: US 2025/0252835 A1
(43) Pub. Date: Aug. 7, 2025

(54) METHOD FOR ACTIVATING A SAFETY PROTOCOL ON A MOBILE TERMINAL, AND CORRESPONDING COMPUTER PROGRAM PRODUCT AND DEVICES

(71) Applicant: GAMEO SA, FRIBOURG (CH)

(72) Inventor: Gilles ROOSS, FRIBOURG (CH)

(21) Appl. No.: 18/856,121

(22) PCT Filed: Apr. 7, 2023
(86) PCT No.: PCT/EP2023/059336

§ 371 Date: Oct. 11, 2024

(30) Foreign Application Priority Data
Apr. 11, 2022 (FR) 2203301

(51) Int. Cl. G08B 21/02

(52) U.S. Cl. CPC G08B 21/02

(57) ABSTRACT

The present disclosure relates to a process for activating, on a mobile terminal, a safety protocol for a lone worker, that includes at least one warning function having program code instructions for configuring the mobile terminal so that at least one alert message is generated on the basis of comparison between on the one hand a quantity based on at least one datum from a sensor, which is integrated in or communicatively connected to the mobile terminal, or from input means of the mobile terminal, and on the other hand a preset activation threshold. Such a method includes: obtaining an identifier of the protocol; and activating the protocol based on the obtained identifier.

### FIELD OF THE INVENTION

The field of the invention is that of the safety of lone workers using a mobile terminal. The invention relates more particularly to a process for activating a safety protocol comprising alert functions on such a mobile terminal.

The invention accordingly has many applications in all areas of activity of lone workers, especially but not exclusively for the maintenance of industrial systems such as distribution or telecommunications networks, systems for generating renewable energy, waste management systems, etc.

### PRIOR ART AND ITS DRAWBACKS

Legislation in many countries demands that people working in the situation of a lone worker be equipped with a solution for triggering an alert in the event of accident or illness. This means an alert device. For over ten years these alert devices have taken the form of mobile applications run on mobile terminals, such applications having different alert and geolocation functions. The lone worker activates the functions necessary for his safety during his work. The functions to be activated vary as per the situation at the time. For example:
Technical equipment may be ‘out of network’ coverage of the mobile terminal (e.g. outside the cellular network). This can be the case when the technical equipment in question is located on the lower levels of a building;
Geolocation can be rapid and reliable via outdoors GPS, but very imprecise in an urban environment and/or in a building;
On-call work activity at night will be limited to rapid and temporary repair, as opposed to planned maintenance during normal working hours;
According to their respective professions, two people from the same company can each work alone on the same site and at the same time, but with different risk levels. Therefore, activating functions may vary according to multiple criteria. The choice of activation of a specific alert function on his mobile terminal requires analysis and contemplation on the part of the lone worker. This is especially true when the lone worker generally has to use several alert functions for the same procedure. Also, interaction with the interface of the mobile terminal often requires learning and a particular level of competence. Therefore, in practice, existing solutions are activated only rarely by lone workers and in most cases are activated poorly.

So there is a need for a technique for performing such alert functions on a mobile terminal which is simple for the lone worker using the terminal in question.

### EXPLANATION OF THE INVENTION

In an embodiment of the invention, a process is proposed for activating a safety protocol on a mobile terminal, comprising at least one alert function comprising program code instructions configuring the mobile terminal so that at least one alert message is generated on the basis of comparison between, on the one hand, a quantity based on at least one datum originating from a sensor, integrated or communicatively connected to the mobile terminal, or originating from input means of the mobile terminal and, on the other hand, a preset activation threshold. According to such a process, the mobile terminal executes:
obtaining an identifier of the protocol;
activating the protocol from the identifier obtained.

In this way, the invention proposes a novel and inventive solution for activating one or more alert functions on a mobile terminal.

To achieve this, it is proposed to activate a safety protocol comprising the alert function or alert functions necessary e.g. for a given activity of a lone worker equipped with the mobile terminal and, when it is not integrated into the mobile terminal, of the corresponding sensor or sensors. In this way, the lone worker is relieved of the analysis and consideration necessary for determining the alert function (or alert functions) to be carried out during the work activity in question. More particularly, such consideration was able to be done prior to the work activity, during designing of the safety protocol to be carried out for this particular work activity.

Also, execution of the protocol is done simply via obtaining of the corresponding identifier (e.g. inputting via input means of the terminal, with or without physical contact between the lone worker using the mobile terminal and the mobile terminal for the input itself (e.g. via a verbal command or a scan as specified hereinbelow)). The present solution is therefore adapted to lone workers having had minimal training on the functionalities of the mobile terminal.

According to some embodiments, the above quantity is representative of said at least one datum or a variation, over a preset time period, of said at least one datum.

According to some embodiments, said at least one alert function belongs to the group comprising:
a function for detecting absence of movement in which at least one alert message is generated when a variation, over a preset time period, of a datum representative of acceleration originating from an accelerometer, integrated or communicatively connected to the mobile terminal, is under a preset low threshold;
a function for detecting fall of the terminal in which at least one alert message is generated when a variation, over a preset time period, of a datum representative of acceleration originating from an accelerometer, integrated or communicatively connected to the mobile terminal, is above a preset high threshold;
a function for detection of loss of verticality in which at least one alert message is generated when an estimated angle between, on the one hand a preset axis of orientation of the sensor and, on the other hand a horizontal plane, is below a preset angular threshold, the angle originating from at least one accelerometer integrated or communicatively connected to the mobile terminal; and
a time alert function in which at least one alert message is generated when a variation of a datum originating from input means of the mobile terminal is under a preset activation threshold over a preset time period.

According to some embodiments, the protocol comprises at least the time alert function. The mobile terminal carries out transmission to a remote server to which the mobile terminal is connected, via a radiocommunications network:
of a position of the mobile terminal at the time of the activation of the protocol; and
the preset time period.

In this way, the remote server can act as a mirror of the mobile terminal.

According to some embodiments, this obtaining comprises a scan, involving at least one imaging sensor of the mobile terminal, of a QR code representative of the identifier.

According to some embodiments, the obtaining comprises capturing an acoustic signal representative of the identifier, involving at least one microphone of the mobile terminal. In this way, identification and activation of the protocol are done simply, with the actual obtaining of the identifier needing no physical contact between the lone worker using the mobile terminal and the terminal in question to input the identifier.

According to some embodiments, prior to activation and from the remote server to which the mobile terminal is connected, via a radiocommunications network the mobile terminal executes downloading of the protocol identified by the identifier obtained.

In this way, the safety protocol can be updated dynamically and transparently for the lone worker using the mobile terminal. This allows greater flexibility and reinforces simplicity of use for the user.

According to some embodiments, activation is carried out when at least one condition belonging to the following group is fulfilled:
the identifier of the protocol is obtained when the mobile terminal is in a preset geographic zone;
the identifier of the protocol is obtained at a time belonging to a preset time window;
a user profile configured on the mobile terminal corresponds to an expected user profile linked to the protocol.

In this way, safeguarding of the implementing of the right safety protocol corresponding effectively to the envisaged work activity is reinforced.

According to some embodiments, the mobile terminal executes playback, on playback means of screen or loudspeaker type of the mobile terminal, of at least one preventive message linked to the protocol.

In this way, safeguarding of the implementing of the right safety protocol corresponding effectively to the envisaged work activity is reinforced. Also, such preventive messages help improve the prevention of accidents and therefore minimise the generation of alert messages.

According to some embodiments, said at least one preventive message is received from the remote server in response to a request sent by the mobile terminal to the remote server.

This is how the preventive message or messages can be updated dynamically and transparently for the lone worker using the mobile terminal. This allows greater flexibility and reinforces simplicity of use for the user.

According to some embodiments, the mobile terminal executes transmission, to a remote alert server to which the mobile terminal is connected via the radiocommunications network, of at least one alert message generated by the safety protocol.

According to embodiments, the remote server and the remote alert server are one and the same server, or else separate servers.

According to some embodiments, said at least one alert message is transmitted with geolocation information representative:
of the position of the mobile terminal at the time of generation of said at least one alert message; or
of the last known position of the mobile terminal after activation of the protocol and prior to generation of said at least one alert message.

In this way, the alert server has access to the geographical position of the mobile terminal when the alert is generated, or to the last known position e.g. in the case of work activity in a zone in which the messages enabling geolocation are not available.

According to some embodiments, said at least one alert message is transmitted with an associated identifier, within the remote alert server, to an expected location of the mobile terminal.

Therefore, the alert server has access to the geographical position of the mobile terminal indirectly, via the identifier linked to a location expected. Also, the same safety protocol can be linked dynamically to activities on different premises by updating of the correspondence between the expected location of the mobile terminal and the identifier linked to the level of the remote alert server.

The invention also relates to a computer program comprising program code instructions for carrying out a process such as described earlier, according to any one of its different embodiments, when it is run on a computer.

The invention also relates to an electronic activation device, on a mobile terminal, of a safety protocol comprising at least one alert function comprising program code instructions configuring the mobile terminal, so that at least one alert message is generated on the basis of comparison between, on the one hand a quantity based on at least one datum originating from a sensor, integrated or communicatively connected to the mobile terminal, or originating from input means of the mobile terminal and, on the other hand a preset activation threshold. Such an electronic activation device comprises a reprogrammable calculation machine or a dedicated computing machine configured to perform the steps of the activation process such as described previously (according to any one of the abovementioned different embodiments).

In this way, the characteristics and advantages of this device are the same as those of the corresponding steps of the activation process described previously. Consequently, they are not described in any more detail.

The invention also relates to a mobile terminal comprising an electronic activation device such as described previously (according to any one of the abovementioned different embodiments).

The invention likewise relates to a system comprising a mobile terminal such as described previously (according to any one of the abovementioned different embodiments) and at least one sensor able to be communicatively connected to the mobile terminal. The safety protocol comprises at least one alert function comprising program code instructions configuring the mobile terminal so that at least one alert message is generated on the basis of comparison between, on the one hand a quantity based on at least one datum originating from the sensors of the system and, on the other hand a preset activation threshold.

### LIST OF FIGURES

Other aims, characteristics and advantages of the invention will become clearer from the following description, given by way of simple illustrative example, and not limiting, in relation to the figures, in which:

FIG. 1 illustrates a mobile terminal on which a safety protocol is activated according to an embodiment of the invention;

FIG. 2 illustrates an example of a device structure for performing the steps of the activation process of FIG. 3 according to an embodiment of the invention;

FIG. 3 illustrates the steps of a process for activating the safety protocol on the terminal of FIG. 1 according to an embodiment of the invention.

### DETAILED DESCRIPTION OF EMBODIMENTS OF THE INVENTION

The general principle of the invention is based on the activation on a mobile terminal of a safety protocol comprising one alert function (or several) for safeguarding the work activity of a lone worker equipped with the mobile terminal in question. More particularly, activation of the protocol follows the obtaining by the mobile terminal of an identifier of the above protocol. In this way, the lone worker is relieved of analysis and consideration necessary to determine the alert function or functions to be implemented during the work activity in question. For example, such consideration was able to be made prior to the work activity, during design of the safety protocol to be implemented for this particular activity.

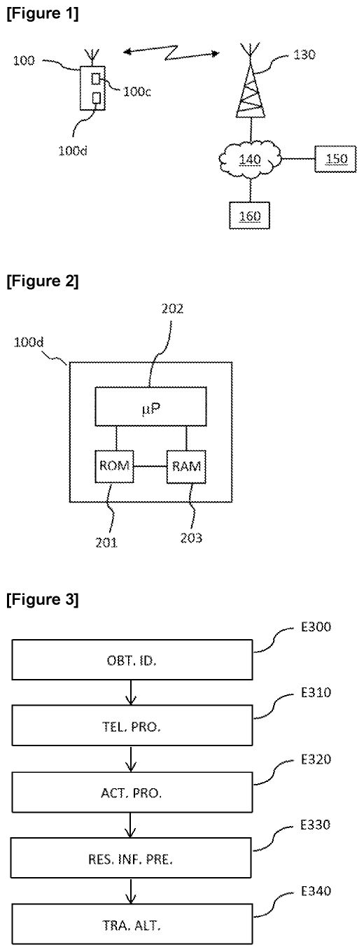

In relation to FIG. 1 a mobile terminal 100 on which a safety protocol is activated is now presented, according to an embodiment of the invention.

More particularly, the terminal 100 (e.g. a smartphone, a tablet, a connected watch, a personal computer, etc.) comprises a sensor 100c outputting data linked to a physical magnitude (or several) to which the sensor 100c is sensitive. For example, the sensor 100c is an accelerometer providing data linked to the acceleration which the sensor 100c undergoes. According to other implementations the sensor 100c is a system able to measure magnitudes along different geometric axes. In such cases, the sensor 100c based on one accelerometer (or several) is able to deliver for example an angle between on the one hand a preset axis of orientation of the sensor and on the other hand a horizontal plane (or any other predefined reference plane). According to other examples, the sensor 100c is a pressure sensor, a magnetometer, a light sensor, etc.

In some embodiments, the sensor 100c is not integrated into the terminal 100, but constitutes a device separate from the terminal 100 intended to be carried by the lone worker using the terminal 100. In such embodiments, the mobile terminal 100 and the sensor 100c comprise means which enable them to be communicatively connected to each other. Such means comprise for example a module implementing wireless communications functions (e.g. according to a Bluetooth or Zigbee protocol) and/or wired communications functions (e.g. according to a CAN protocol (for ‘Controller Area Network’ in English)).

In some embodiments, the terminal 100 comprises a plurality of sensors 100c, each sensor 100c outputting data linked to a physical magnitude (or several) to which the sensor 100c in question is sensitive.

In some embodiments, the terminal 100 comprises means allowing it to be communicatively connected to a plurality of sensors 100c separate from the terminal 100. In some embodiments, the terminal 100 comprises an integrated sensor 100c (or several) as well as means allowing it to be communicatively connected to one sensor 100c (or several) separate from the terminal 100.

Referring again to FIG. 1, the terminal 100 comprises wireless communication means, e.g. according to a cellular protocol of 2G, 3G, 4G, 5G type, etc. in terms of 3GPP (for ‘3rd Generation Partnership Project’ in English) or LoRa®, NB-IoT (for ‘Narrowband Internet of things’ in English), Cat-M, letting it connect to a radiocommunications network via a base station 130. In this way, the terminal 100 is able to communicate via the network core 140 with a remote server 160, for example to download the safety protocol as described further hereinbelow in relation to FIG. 3. Also, the terminal 100 is able to communicate via the network core 140 with an alert server 150 (e.g. a server of an emergency service), for example to transmit the alert message (or messages) generated by the alert function (or functions) executed on the terminal 100 as described further hereinbelow in relation to FIG. 3.

According to the embodiments, the remote server 160 and the alert server 150 are one and the same server, or else separate servers as in the embodiment of FIG. 1. Also, so as to carry out all or some of the steps of the activation process of FIG. 3 (according to any one of the embodiments described hereinbelow in relation to FIG. 3), the terminal 100 comprises a device 100d comprising for example (FIG. 2) a live memory 203 (for example RAM memory), a processing unit 202 equipped for example with a processor and piloted by a computer program stored in a read-only memory 201 (for example ROM memory or a hard drive). On initialisation, the code instructions of the computer program are loaded for example into the live memory 203 prior to being executed by the processor of the processing unit 202.

This FIG. 2 illustrates one particular way only, of several possible ways, of making the device 100d so that it performs certain steps of the activation process according to the invention (as per any one of the embodiments and/or variants described hereinbelow in relation to FIG. 3). In fact, these steps can be performed equally on a reprogrammable calculation machine (a computer PC, a processor DSP or a microcontroller) running a program comprising a sequence of instructions, or on a dedicated computing machine (for example a set of logic gates such as a FPGA or an ASIC, or any other equipment module).

In the event where the device 100d is carried out with a reprogrammable calculation machine, the corresponding program (that is, the sequence of instructions) could be stored in a removable storage medium (such as for example a CD-ROM, a DVD-ROM, a USB key) or not, this storage medium being readable partially or fully by a computer or a processor.

In some embodiments, the device 100d is included in the mobile terminal 100. In relation to FIG. 3 the steps of a process for activating of the safety protocol on the terminal 100 will now be presented according to an embodiment of the invention. More particularly, the safety protocol comprises at least one alert function comprising program code instructions configuring the mobile terminal 100 so that one alert message (or several) is generated on the basis of comparison between:
on the one hand a quantity based on at least one datum which has originated from either one sensor 100c (or several), or from input means of the mobile terminal 100; and
on the other hand a preset activation threshold.

As described above in relation to FIG. 1, as per the embodiments the sensor 100c (or sensors) is either integrated into the terminal 100 or communicatively connected to the terminal 100. Also, the input means comprise for example a physical keyboard, a touch screen or even a microphone of the terminal 100.

Similarly, as per the relevant implementations the above quantity is either directly representative of said at least one datum, or representative of a variation over a preset time period of said at least one datum. In this way, the alert functions are for example functions of the type:
a function for detecting absence of movement in which an alert message (or several) is generated when over a preset time period a variation of a datum representative of acceleration is under a preset low threshold. In this case, the sensor 100c is for example an accelerometer, integrated or communicatively connected to the terminal 100, delivering the datum representative of the acceleration in question;
a function for detecting fall of the terminal in which an alert message (or several) is generated when a variation, over a preset time period, of a datum representative of acceleration is above a preset high threshold. In this case, the sensor 100c is for example an accelerometer, integrated or communicatively connected to the terminal 100, delivering the datum representative of the acceleration in question. The preset high threshold is for example strictly greater than the preset low threshold so as to on the one hand effectively implement a function for detection of fall and on the other hand a function for detecting absence of movement;
a function for detection of loss of verticality in which an alert message (or several) is generated when an angle estimated between, on the one hand a preset axis of orientation of the sensor 100c and on the other hand a horizontal plane (or any other predefined reference plane) is below a preset angular threshold, for example an angular threshold of twenty degrees in the case of the horizontal plane. Such an estimated angle originates for example from a module implementing one sensor 100c (or several), integrated or communicatively connected to the terminal 100 of accelerometer type; and
a time alert function in which one alert message (or several) is generated when a variation, over a preset time period, of a datum originating from the above input means of the terminal 100 is under a preset activation threshold. For example, the alert function generates an alert message when the lone worker using the terminal 100 fails to press a key (physical key of a physical keyboard of the terminal 100 or virtual key materialised on a touch screen of the terminal 100) prior to the end of the preset time period. In some embodiments, the time alert function comprises playback (e.g. periodically or after a preset delay less than or equal to the preset time period), on playback means of the terminal 100 (e.g. a screen or a loudspeaker), of a reminder informing the lone worker using the terminal 100 that he must act on the above input means prior to the end of the preset time period.

In some embodiments, the time alert function comprises input by the lone worker using the terminal 100 (e.g. via the above input means of the terminal 100) and during activation of the protocol, of the preset time period and/or of the preset time delay. In some embodiments in which the safety protocol comprises at least the time alert function, the terminal 100 executes transmission to the remote server 160:
of a position of the terminal 100 at the time of activation of the protocol; and
of the preset time period.

In this way, the remote server 160 acts as a mirror of the terminal 100. Such embodiments are for example significant when the lone worker using the mobile terminal 100 has to work in a white area, i.e. outside radiocommunications network coverage (e.g. for basement work). In fact, since the remote server 160 knows the position of activity of the lone worker using the terminal 100 it can itself generate an alert if the terminal 100 does not return to a coverage zone of the radiocommunications network on completion of the preset time period.

Referring again to FIG. 3, during a step E300, the terminal 100 obtains an identifier of the protocol.

For example, such obtaining occurs via the input means above the terminal 100. In this case, the user of the terminal 100 directly inputs the identifier via the input means of the terminal 100.

Alternatively, obtaining the identifier comprises a scan, involving an imaging sensor (or several) of the terminal 100, of a QR (for ‘Quick Response’ in English) code representative of the identifier. The terminal 100 obtains the identifier via interpretation of the information conveyed by the QR code.

According to another alternative, obtaining the identifier comprises capture, involving a microphone (or several) of the terminal 100, of an acoustic signal (e.g. a verbal signal) representative of the identifier. The terminal 100 obtains the identifier for example by executing a voice recognition technique applied to the captured acoustic signal.

In this way, identification and activation of the protocol occur simply, the actual obtaining of the identifier (i.e. independently of the prehension itself of the terminal 100) needing no physical contact between the lone worker using the terminal 100 and the terminal 100 in question to input the identifier. This effect is obtained whether via the above scan, via the above capture or via any other means of capturing information representative of the identifier needing no physical contact between the user of the terminal 100 and the terminal 100 in question for the actual capture. The present solution is therefore adapted to lone workers who have had minimal training on the functionalities of the terminal 100. For example, the QR code was generated prior to the work activity, e.g. when the safety protocol for the planned work activity was designed, and then printed out to be given to the lone worker during the work activity in question.

Referring again to FIG 3, during a step E310 the terminal 100 downloads the safety protocol identified by the identifier obtained during execution of step E300, prior to activation and from the remote server 160.

In this way, the safety protocol can be updated dynamically and transparently for the lone worker using the terminal 100. This allows greater flexibility and reinforces simplicity of use for the user.

However, in some embodiments step E310 is not performed and the safety protocol is implemented on the terminal 100 prior to its use by the lone worker (e.g. by configuration in a factory or by a prime contractor who plans the work activities before they are carried out by the lone worker).

In some embodiments, the identifier of the protocol is representative of the alert function (or functions) of the safety protocol before being activated. The alert function (or functions) in question are themselves either downloaded from the remote server 160, or implemented on the terminal 100 prior to being utilised. The safety protocol is now determined by the identifier obtained and then activated on the terminal 100.

In reference again to FIG. 3, during a step E320 the terminal 100 activates the safety protocol corresponding to the identifier obtained. For example, several protocols are implemented on the terminal 100 and the protocol corresponding to the identifier obtained during execution of step E300 is activated.

However, in some embodiments activation of the safety protocol corresponding to the identifier obtained is carried out when also at least one extra condition belonging to the following group is fulfilled:
the identifier of the protocol is obtained when the terminal 100 is in a preset geographic zone. For example, the position of the terminal 100 is determined via a geolocation receiver (e.g. of GPS, Galileo, Beidou or Glonass type) implemented in the terminal 100;
the identifier of the protocol is obtained at a time belonging to a preset time window;
a user profile configured on the terminal 100 corresponds to an expected user profile linked to the protocol. For example, some protocols implemented on the terminal 100 are inaccessible only to some users of the terminal 100, identified as such via the user profile to which they are connected on the terminal 100.

In this way, safeguarding of the implementing of the right safety protocol corresponding effectively to the envisaged work activity is reinforced.

Referring again to FIG. 3, during a step E330 the terminal 100 plays back a preventive message (or several messages) linked to the protocol via playback means of screen or loudspeaker type of the terminal 100.

Such playback combines for example texts, images and links to additional resources such as videos. The aim is to avoid an accident for the lone worker by pointing out to him on his terminal 100 the risks and preventive actions necessary for the activity to be carried out, for example on a given site and/or at a particular moment.

In this way, safeguarding of the implementation of the right safety protocol corresponding effectively to the planned work activity is reinforced. Also, such preventive messages help improve the prevention of accidents and therefore minimise the generation of alert messages.

In some embodiments, the terminal 100 is connected to the remote server 160 to obtain the preventive message (or messages) linked to the safety protocol and play them back to the lone worker. For example, the preventive message (or messages) is received from the remote server in response to a request sent by the terminal 100 to the remote server 160. In this way, the preventive message (or messages) can be updated dynamically and transparently for the lone worker using the terminal 100. This allows greater flexibility and reinforces simplicity of use for the user.

However, in some embodiments, step E330 is not performed and no preventive message linked to the protocol is played back by the terminal 100.

Referring again to FIG. 3, during a step E340 the terminal 100 transmits one (or more) alert message generated by the safety protocol to the alert server 150. In some embodiments, the alert message (or messages) is transmitted with geolocation information representative:
of the position of the terminal 100 at the time of the generation of the alert message (or messages); or
of the last known position of the terminal 100 after activation of the protocol and before generation of the alert message (or messages).

In this way, the alert server 150 has access to the geographical position of the terminal 100 at the time of generation of the alert, or to the last known position e.g. in the case of activity in a zone in which the messages enable geolocation are not available. For example, the position of the terminal 100 is determined via a geolocation receiver (e.g. of GPS, Galileo, Beidou or Glonass type) implemented in the terminal 100, and/or via identification of a radio signal of tag type (e.g. a Bluetooth beacon or WiFi terminal) received by the terminal 100.

In some embodiments, the alert message (or messages) is transmitted with an associated identifier, within the remote alert server 150, to an expected location of the terminal 100. In this way, the alert server 150 has access to the geographical position of the terminal 100 indirectly, via the identifier linked to an expected location. Also, the same safety protocol can be linked dynamically to activities on different premises by updating of the correspondence between the expected location of the terminal 100 and the identifier linked to the level of the remote alert server 150. According to embodiments, the identifier linked to an expected location and the identifier of the protocol are one and the same identifier, or else different identifiers.

However, in some embodiments, step E340 is not executed and no alert message is transmitted via the terminal 100, for example when no condition allowing generation of such an alert is fulfilled. This can be the case when the activity of the lone worker is proceeding smoothly.

1. A process for activating, on a mobile terminal, a safety protocol for a lone worker comprising at least one alert function comprising program code instructions configuring the mobile terminal so that at least one alert message is generated on the basis of comparison between on the one hand a quantity based on at least one datum originating from a sensor, integrated or communicatively connected to the mobile terminal, or originating from input means of the mobile terminal, and on the other hand a preset activation threshold,
characterised in that the mobile terminal executes:
obtaining an identifier of the protocol;
activating the protocol from the identifier obtained.

2. The process according to claim 1, wherein said quantity is representative of said at least one datum or a variation, over a preset time period, of said at least one datum.

3. The process according to claim 1, wherein said at least one alert function belongs to the group comprising:
a function for detecting absence of movement in which at least one alert message is generated when a variation of a datum representative of acceleration originating from an accelerometer over a preset time period, integrated or communicatively connected to the mobile terminal, is under a preset low threshold;
a function for detecting fall of the terminal in which at least one alert message is generated when a variation, over a preset time period, of a datum representative of acceleration originating from an accelerometer, integrated or communicatively connected to the mobile terminal, is above a preset high threshold;
a function for detection of loss of verticality in which at least one alert message is generated when an angle estimated between, on the one hand, a preset axis of orientation of the sensor and, on the other hand, a horizontal plane is below a preset angular threshold, the angle emanating from at least one accelerometer integrated or communicatively connected to the mobile terminal; and
a time alert function in which at least one alert message is generated when a variation of a datum originating from input means of the mobile terminal is under a preset activation threshold over a preset time period.

4. The process according to claim 3, wherein said protocol comprises at least said time alert function, and wherein said mobile terminal executes transmission to a remote server to which the mobile terminal is connected, via a radiocommunications network, of a position of the mobile terminal at the time of activation of the protocol; and said preset time period.

5. The process according to claim 1, wherein said obtaining comprises a scan, involving at least one imaging sensor of said mobile terminal, of a QR code representative of said identifier.

6. The process according to claim 1, wherein said obtaining comprises capturing, involving at least one microphone of said mobile terminal, of an acoustic signal representative of said identifier.

7. The process according to claim 1, wherein the mobile terminal performs a download of the protocol identified by the identifier obtained prior to activation and from a remote server to which the mobile terminal is connected, via a radiocommunications network.

8. The process according to claim 1, wherein said activation is carried out when at least one condition belonging to the following group is fulfilled:
said identifier of the protocol is obtained when the mobile terminal is in a preset geographic zone;
said identifier of the protocol is obtained at an instant belonging to a preset time window;
a user profile configured on the mobile terminal corresponds to an expected user profile linked to the protocol.

9. The process according to claim 1, wherein the mobile terminal executes playback, on playback means of screen or loudspeaker type of the mobile terminal, of at least one preventive message linked to said protocol.

10. The process according to claim 9 wherein said at least one preventive message is received from a remote server in response to a request sent by the mobile terminal to the remote server.

11. The process according to claim 1, wherein the mobile terminal executes transmission, to a remote alert server to which the mobile terminal is connected via the radiocommunications network, of at least one alert message generated by the safety protocol.

12. The process according to claim 11 wherein said at least one alert message is transmitted with geolocation information representative:
of the position of the mobile terminal at the time of generation of said at least one alert message; or
of the last known position of the mobile terminal after activation of the protocol and prior to generation of said at least one alert message.

13. The process according to claim 11 wherein said at least one alert message is transmitted with an associated identifier, within the remote alert server, to an expected location of the mobile terminal.

14. A computer program product comprising program code instructions for carrying out the process according to claim 1, when said program is run on a computer.

15. An electronic activation device, on a mobile terminal, of a safety protocol for a lone worker, comprising at least one alert function comprising program code instructions configuring the mobile terminal so that at least one alert message is generated on the basis of comparison between, on the one hand, a quantity based on at least one datum originating from sensor, integrated or communicatively connected to the mobile terminal, or originating from input means of the mobile terminal and, on the other hand, a preset activation threshold,
characterised in that it comprises a reprogrammable calculation machine or a dedicated computing machine configured to carry out:
obtaining an identifier of the protocol;
activating the protocol from the identifier obtained.

16. A mobile terminal comprising an electronic device according to claim 15.

17. A system comprising a mobile terminal according to claim 16 and at least one sensor able to be communicatively connected to the mobile terminal, the safety protocol for a lone worker comprising at least one alert function comprising program code instructions configuring the mobile terminal so that at least one alert message is generated on the basis of comparison between, on the one hand a quantity based on at least one datum originating from the sensors of the system and on the other hand a preset activation threshold.
